(19) United States
(12) Patent Application Publication
(10) Pub. No.: US 2025/0383763 A1
(43) Pub. Date: Dec. 18, 2025

(54) TOUCH SENSOR USER INTERFACE FOR A TEST AND MEASUREMENT INSTRUMENT

(71) Applicant: Tektronix, Inc., Beaverton, OR (US)

(72) Inventors: Jonathan D. Clem, Hillsboro, OR (US); Devon Mickels, Beaverton, OR (US)

(21) Appl. No.: 19/232,165

(22) Filed: Jun. 9, 2025

Related U.S. Application Data
(60) Provisional application No. 63/660,367, filed on Jun. 14, 2024.

(51) Int. Cl. G06F 3/0488; G06F 3/044; G06F 3/045

(52) U.S. Cl. CPC G06F 3/0488; G06F 3/044; G06F 3/045

(57) ABSTRACT

A touch sensor has a first conductive material separated into one or more primary segments and a second conductive material positioned a predetermined distance from the first conductive material. The touch sensor also has a controller configured to receive input from each of the one or more primary segments of the first conductive material, and based on the received input, determine whether a touch is present at one of the one or more primary segments.

### CROSS-REFERENCE TO RELATED APPLICATIONS

This disclosure is a non-provisional of and claims benefit from U.S. Provisional Application No. 63/660,367, titled “TOUCH SENSOR USER INTERFACE FOR A TEST AND MEASUREMENT INSTRUMENT,” filed on Jun. 14, 2024, the disclosure of which is incorporated herein by reference in its entirety.

### TECHNICAL FIELD

This disclosure relates to test and measurement instruments, and more particularly to physical user interfaces for a test and measurement instrument.

### BACKGROUND

Test and measurements instruments, particularly oscilloscopes, typically have knobs and/or rotary encoders to allow a user to control the instrument. The analog nature of older instruments required controls of this kind, but even as technology has progressed to allow for touch-based user interfaces, users are still reluctant to move toward touch-based interfaces for test and measurement instruments. Specifically, users often prefer the tactile nature of analog controls, which allow them to keep their eyes on the instrument's display screen while configuring the instrument with the analog controls. This is in contrast to touch-based controls, which typically do not offer tactile feedback.

Additionally, existing touch-based control systems come with disadvantages. Generally, touch sensors are either resistive or capacitive. In resistive touch sensors, a deformable membrane is deformed by a user's touch, causing the membrane to form an electrical short at the touch point. Although resistive sensors are simplistic and mostly immune to electromagnetic interference, they are unable to recognize multiple touch points at a time. And, due to the repeated deformation, resistive touch sensors often degrade over time with repeated use.

Capacitive sensors, conversely, measure capacitance at specific points on a touch surface, which may change due to the presence of a finger. While capacitive sensors can recognize multiple touch locations and do not require mechanical deformation that could cause materials to degrade over time, capacitive sensors are complex and vulnerable to interference from external electrical fields.

Configurations of the disclosed technology address shortcomings in the prior art.

### BRIEF DESCRIPTION OF THE DRAWINGS

FIG. 1 is a functional block diagram of a test and measurement instrument having a touch sensor, according to an example configuration.

FIG. 2 is a representation of a touch sensor, according to an example configuration.

FIG. 3 is a conceptual representation of a touch location identification system for the touch sensor of FIG. 2.

FIG. 4A is a diagram of voltage decay for the touch sensor of FIG. 2 in an untouched state.

FIG. 4B is a diagram of voltage decay for the touch sensor of FIG. 2 in a touched state.

FIG. 5 is a representation of a test and measurement instrument implementing a touch sensor, according to an example configuration.

FIG. 6A is a representation of the test and measurement instrument of FIG. 5, showing control of a cursor starting at a first touch position.

FIG. 6B is a representation of the test and measurement instrument of FIG. 5, showing control of a cursor continuing to a second touch position.

FIG. 6C is a representation of the test and measurement instrument of FIG. 5, showing control of a cursor finishing at a third touch position.

FIG. 7 is a circuit diagram showing an electrostatic discharge protection circuit implemented with a touch sensor, according to an example configuration.

### DESCRIPTION

As described herein, aspects of the disclosure are directed to a skin resistance touch sensor configured to detect the location of a user's physical touch, such as with a finger, using a matrix arrangement of exposed conductors. In particular, aspects utilize the resistance of skin between exposed conductors to detect a change in decay rate of an electrical pulse applied to the exposed conductors, allowing for the location of a touch on the exposed conductors to be determined. Furthermore, aspects of the disclosed technology implement skin resistance touch sensors as controls for test and measurement instruments.

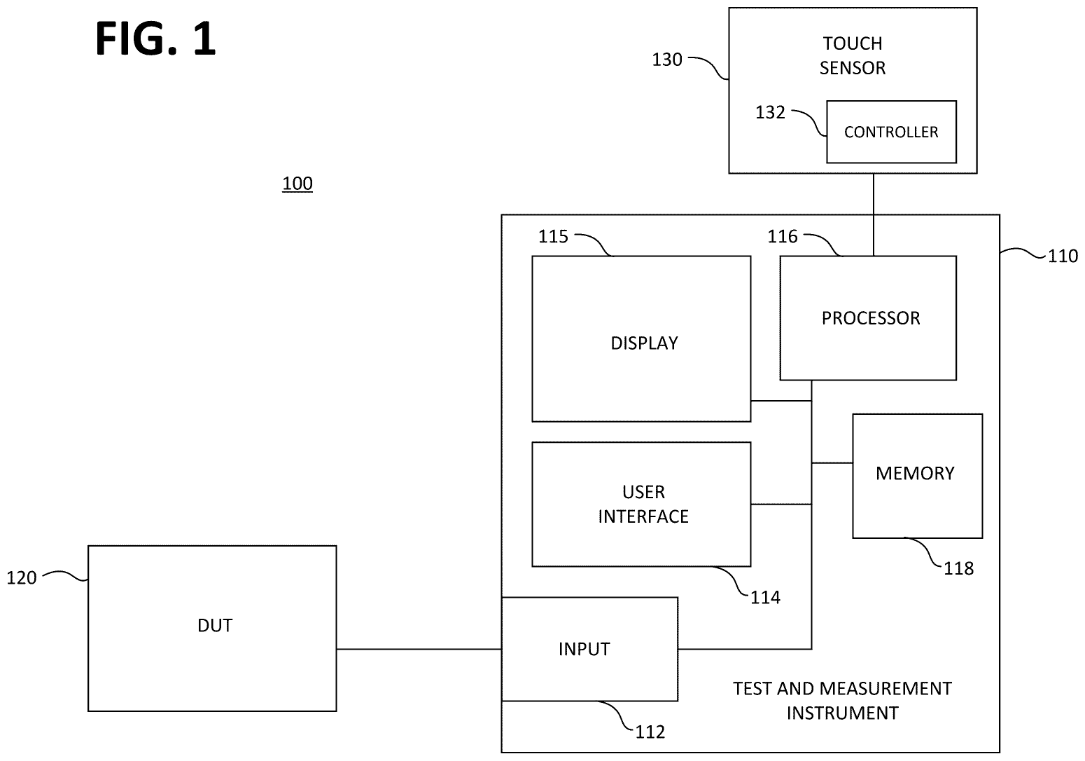

FIG. 1 is a functional block diagram showing portions of a configuration for a test and measurement system 100. The test and measurement system 100 includes a test and measurement instrument 110, a device under test (DUT) 120, and a touch sensor 130. The test and measurement 110 may be an oscilloscope, for example, and as illustrated, the test and measurement instrument 110 includes an input 112 for receiving signals acquired from the DUT 120, a user interface 114, a display 115, a processor 116, and a memory 118.

In configurations, the touch sensor 130 is a skin resistance touch sensor, according to embodiments described below. In some configurations, the touch sensor 130 is integral to the test and measurement instrument 110. That is, the touch sensor 130 is part of the controls on the device itself and may be considered part of the user interface 114. In still other configurations, the touch sensor 130 is separate from the test and measurement instrument 110, but nonetheless electrically connected with the test and measurement instrument 110, to allow for user control of test and measurement operations. For example, in some configurations, the touch sensor 130 is configured to control display features of the test and measurement instrument 110, such as cursor position or zoom functions. Accordingly, a touch input can be received from a user at the touch sensor 130, and the processor 116 receiving a signal from the touch sensor 130 can control the display 115 to adjust particular display features based on the received touch input.

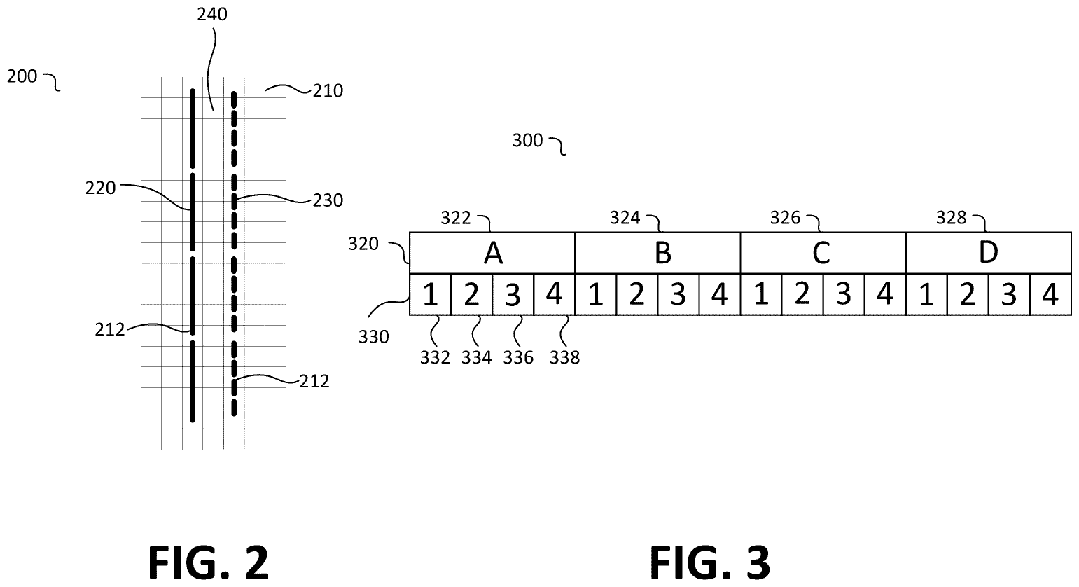

FIG. 2 shows a representation of a touch sensor 200, according to embodiments of the disclosed technology. In configurations, the touch sensor 200 is implemented with a test and measurement instrument, such as an oscilloscope. In other words, the touch sensor 200 can be implemented in the configuration of a test and measurement system shown in FIG. 1, and the touch sensor 200 is configured to receive touch input from a user to control operations of the test and measurement instrument. In particular, the touch sensor 200 may be configured to control the adjustment of display features, including but not limited to cursor position and display zoom.

As illustrated in FIG. 2, configurations of the touch sensor 200 are embodied in a mesh 210. Specifically, exposed, conductive wires are threaded through gaps 212 in the mesh 210 while the mesh 210 is formed of a non-conductive material. The gaps 212 are not visible in FIG. 2 as they are filled with the conductive wires. The conductive wires are threaded such that a pattern of several individual segments is formed. For instance, in configurations such as the example shown in FIG. 2, a conductive wire is threaded in the mesh 210 to form a primary line 220 of conductive wire, in segments, and a secondary line 230 of conductive wire in shorter segments than those forming the primary line 220. An air gap 240 physically separates the primary line 220 and the secondary line 230. That is, a portion of the mesh 210 between the primary line 220 and the secondary line 230 has no conductive wire threaded through it. In configurations, the air gap 240 is sized such that a user's finger can simultaneously contact both the primary line 220 and the secondary line 230, as described below.

The shorter segments of the secondary line 230, in some configurations, are arranged such that they span the length of a corresponding segment of the primary line 220. The touch sensor 200 of FIG. 2 shows an example of this arrangement, wherein each individual segment of the primary line 220 has four neighboring segments of secondary line 230. As will be discussed in further detail below, the arrangement of segments of the secondary line 230 corresponding to longer segments of the primary line 220 allows for the touch sensor 200 to identify a user's touch based on the position of the touch along the length of the touch sensor 200. Although FIG. 2 shows an arrangement having four segments of the primary line 220 and sixteen segments of the secondary line 230—four segments per segment of the primary line 220—it should be understood that other arrangements of conductive wire may be implemented, depending on the desired functions of the touch sensor 200.

Additionally, although not shown in FIG. 2, each of the primary line 220 and the secondary line 230 are electrically connected to a controller or processor. In some embodiments a controller 132 is integrated into the touch sensor 130, as illustrated in FIG. 1, while in other embodiments the touch sensor 130 may be controlled by the processor 116 of the test and measurement system 100. In yet other embodiments, control of the touch sensor 130 may include both the controller 132 and processor 116. In configurations, the touch sensor 200 detects a user's touch in a particular location based on measured decay time of an electrical pulse that is applied to the conductive wires. More specifically, the controller 132 or processor 116 (FIG. 1) sends an electrical pulse to charge the primary line 220 up to a known voltage. In example configurations, the pulse charges the primary line 220 to three volts, although other voltages could be chosen. Once the pulse charges the primary line 220, there is nothing to actively maintain the charge of the primary line 220, and the charge naturally falls back down to zero volts through a return path to the controller or processor. Without a user's finger touching the primary line 220, the amount of time it takes for charge on the primary line 220 to return to its non-charged voltage is consistent and is thus a known quantity. Put differently, the controller 132 or processor 116 can be configured to measure decay time of the primary line 220 and compare the measured decay time with the known decay time for a charged but untouched primary line 220. The controller 132 or processor 116 thus identifies the primary line 220 as being untouched when the measured decay time matches the known decay time for an untouched primary line 220.

However, when a user's finger touches the touch sensor 200, the user's finger creates a conductive path between the primary line 220 and the secondary line 230. As previously mentioned, the air gap 240 between the primary and the secondary line 230 is sized such that a user's finger can simultaneously touch both lines. Accordingly, when the user's finger touches both lines, the charge of the primary line 220 at the segment being touched is shorted to a neighboring segment or segments of the secondary line 230. When shorted in this way, the decay time of the primary line 220 changes—namely, the charge of the primary line 220 decays faster.

The controller or processor of a test and measurement instrument implementing the touch sensor 200 can therefore be configured to detect a faster decay time coming from a particular location of the sensor, and, accordingly, detect that a user is touching that particular location. FIG. 3 is a visualization of possible touch locations for a touch sensor 300. In the example shown in FIG. 3, the touch sensor 300 is just as described above with regard to the touch sensor 200 of FIG. 2. That is, the touch sensor 300 has a primary line 320 and a secondary line 330, and each of the primary line 320 and secondary line 330 has multiple segments. More particularly, as shown in FIG. 2, the primary line 320 of FIG. 3 has four segments: a first primary segment 322, a second primary segment 324, a third primary segment 326, and a fourth primary segment 328. The secondary line 330 has sixteen segments, with four short segments spanning the length of each segment of the primary line 320.

Within the length of each segment of the primary line 320, then, is a first secondary segment 332, a second secondary segment 334, a third secondary segment 336, and a fourth secondary segment 338. To demonstrate the process of identifying a touch at a particular location on the touch sensor 300, labels can be assigned to each of the segments of the primary line 320 and the secondary line 330 to distinguish the segments. For instance, a letter can be assigned to each segment of the primary line 320. As shown in FIG. 3, the first primary segment 322 is labeled “A,” the second primary segment 324 is labeled “B,” the third primary segment 326 is labeled “C,” and the fourth primary segment 328 is labeled “D.” A number can then be assigned to each segment of the secondary line 330, and therefore the first secondary segment 332 is labeled “1,” the second secondary segment 334 is labeled “2,” the third secondary segment 336 is labeled “3,” and the fourth secondary segment 338 is labeled “4.” With these labels, a particular and unique location along the touch sensor 300 can be identified—e.g., contacting the first primary segment 322 and the neighboring fourth secondary segment 338 can be identified as a touch at location A4.

In some configurations, the secondary segments having the same numerical positions relative to different primary segments are electrically shorted together. Put differently, the first secondary segment 332 neighboring first primary segment 322 (location A1) is connected to the secondary segments at locations B1, C1, and D1. These locations of secondary segments can be understood as having the same numerical labels because they are shorted in this way and have the same return paths. Identification of a touch therefore corresponds to a faster decay time at a particular segment of the primary line 320 and a charge at a segment of the secondary line 330 identified with either a 1, 2, 3, or 4.

To detect the location of a touch, as mentioned above, a controller or processor sends pulses of charge at a certain voltage to the primary line 320. More specifically, the controller or processor drives each of the primary segments to be logic high (voltage present) or logic low (voltage not present), one at a time. The controller or processor then loops through measurements of charge decay time at each combination of a primary segment with a secondary segment. For the example touch sensor 300 shown in FIG. 3, there are sixteen combinations of primary segments with secondary segments. When the controller or processor drives a logic high, a touch at a particular primary segment acts as a pullup resistor, and the pulse does not decay. But when a primary segment is driven with a logic low, the resistance of the skin provides a parallel resistive path that depletes the charge of the primary line 320 faster than the known decay without a touch.

In this way, a predetermined threshold decay time can be set, and the controller or processor is configured to detect a decay time below the predetermined threshold while cycling through the sixteen combinations of primary and secondary segments. If a decay time below the predetermined threshold is detected, the controller or processor recognizes a touch at the corresponding location of the faster decay time. If no decay time below the predetermined threshold is detected, the controller or processor recognizes that the touch sensor 300 is not being touched.

In configurations, the controller or processor is configured to detect movement of a user's finger along the touch sensor 300. That is, a change in touch location over time can be detected. If, for example, a user touches the touch sensor 300 at location A1 shown in FIG. 3, then swipes their finger along the touch sensor 300 and maintains contact with the touch sensor 300 until their finger reaches location C1, the controller or processor will detect faster decay times at each location between A1 and C1 over time. As will be discussed in further detail below, this recognition of location change allows the touch sensor 300 to used to control continuous scrolling operations, continuous incrementing, continuous decrementing, or other similar operations.

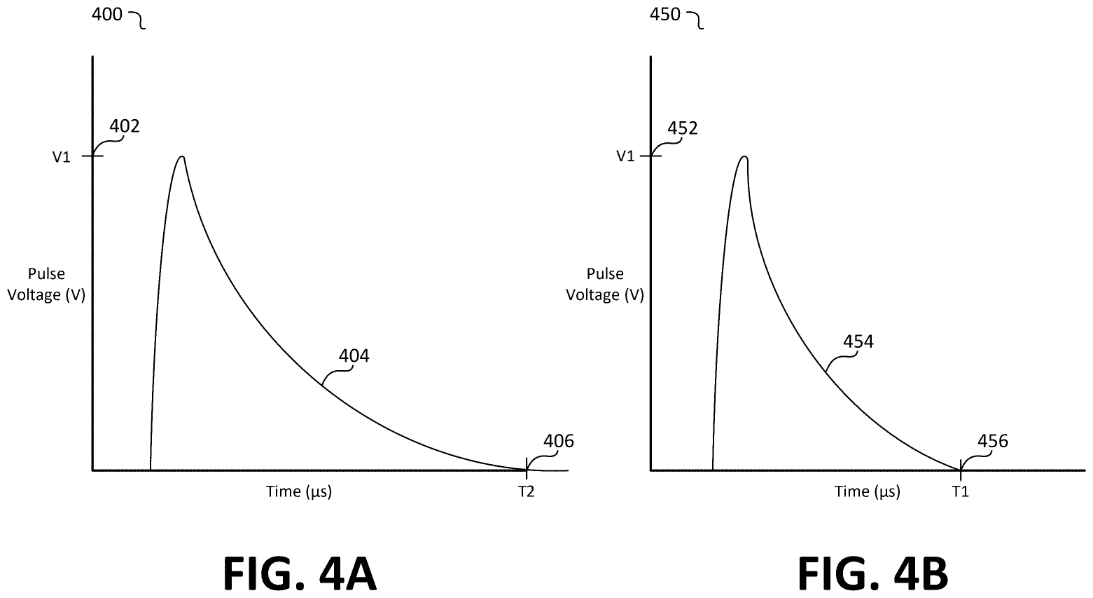

As mentioned, embodiments of the disclosed touch sensor detect physical location of a physical touch based on pulse decay time. FIGS. 4A-4B show example plots of pulse decay time. Specifically, FIG. 4A shows an example plot 400 of decay time when no touch is present, and FIG. 4B shows an example plot 450 of decay time when a touch is present. As shown in FIG. 4A, the primary line of the disclosed touch sensor is charged to a voltage 402, identified as V1. In some embodiments the primary line may be charged to V1, for example 3 Volts, within a few hundred nanoseconds or less. Without a user's skin contacting the touch sensor, the pulse to the voltage 402 decays along an expected decay curve 404, taking a total amount of time 406 (identified as T2) to decay back to zero.

Referring now to FIG. 4B, in a scenario where the primary line is touched, the primary line is first charged to a voltage 452 equal to voltage 402 of FIG. 4A. Accordingly, the voltage 452 is similarly identified with V1. With the user's skin contacting the touch sensor, however, the pulse to voltage 452 decays much faster and follows a faster decay curve 454. Decaying along the faster decay curve 454 takes a total amount of time 456 identified with T1, where T1 is a shorter amount of time than T2. As previously discussed, a predetermined threshold decay time can be set to detect whether a touch is present. Referring to FIGS. 4A-4B, it can be understood that the predetermined threshold can be set to be T2 or some amount less than T2. Consequently, when a decay time T1 is detected, with T1 being less than T2 and less than the predetermined threshold, the decay time T1 indicates a touch at the corresponding location where the decay time T1 is detected. In one embodiment the decay time T2 may be on the order of 100-300 microseconds, although other decay times could be selected based on a resistance of the return sensing path. In embodiments, the voltage of the particular segments 220, 230 (FIG. 2) may be sensed by the controller 132 or processor 116 illustrated in FIG. 1. In one embodiment the voltage applied to the segments 220, 230 is applied by an input/output (I/O) pin during one time period and is sensed by the same I/O pin during another time period. In other embodiments separate pins could be used.

Referring once again to FIGS. 2-3, although example configurations are shown as having four primary segments and sixteen secondary segments-four secondary segments per primary segment—it should be understood that still other configurations of the disclosed touch sensor are possible. For instance, in some configurations, a greater or fewer number of primary segments and secondary segments are implemented. The touch sensor 200 shown in FIG. 2 can be elongated to have more than four primary segments, in some examples, with the same number of secondary segments associated with each primary segment. Or, in some examples, a greater or fewer number of secondary segments span the length of each primary segment.

Moreover, configurations of the disclosed touch sensor need not be linear. In some example configurations, the arrangement of primary and secondary segments shown in FIG. 2 is duplicated and positioned adjacent the illustrated primary line 220 and secondary line 230. In this way, a touch sensor can be arranged such that it has a first primary line, a first secondary line, a second primary line, and a second secondary line. With this example arrangement, a user interacting with the touch sensor can move their finger vertically—i.e., in the direction of the length of the touch sensor 200 shown in FIG. 2—or horizontally. A controller or processor can then be configured to detect the location of a touch in an XY plane and can be further configured to detect movement of a touch in any direction in the two-dimensional XY plane.

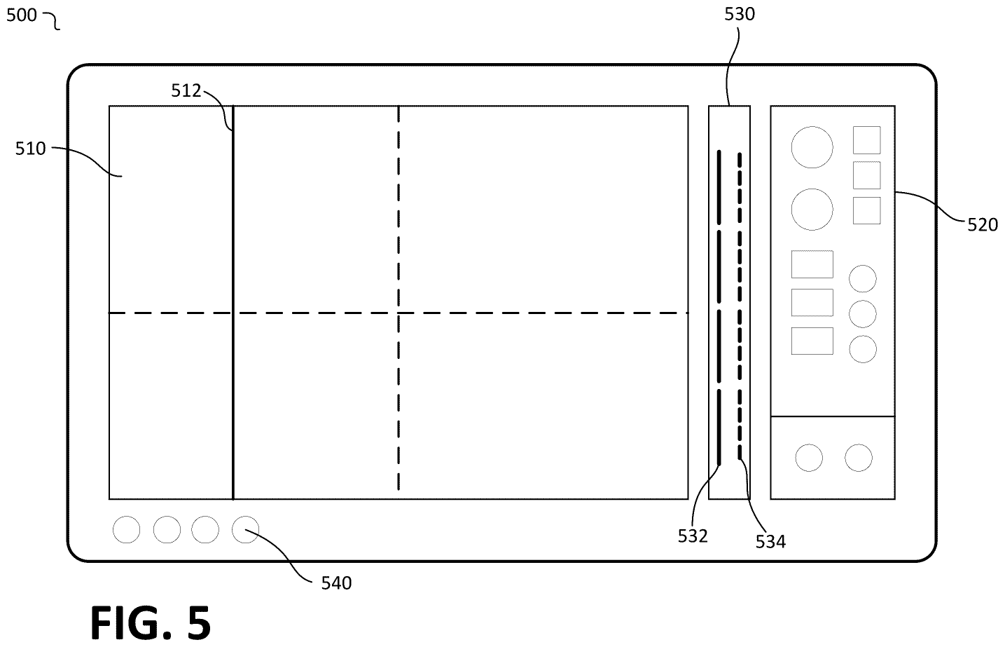

FIG. 5 shows an example test and measurement instrument 500 implementing a touch sensor 530, according to configurations. As shown, the test and measurement device 500 has a display 510, a user interface 520, the touch sensor 530, and inputs 540. The display 510, in some configurations, also has a cursor 512 for identifying particular portions of a displayed signal. As will be discussed in further detail below, the position of the cursor 512 is controllable with the touch sensor 530, based on the detection of a touch along the primary line 532 and secondary line 534.

Referring to the example cursor 512 of FIG. 5, the cursor 512 can be moved back and forth across the display 510 using the touch sensor 530. That is, the cursor 512 is configured to move toward and away from the touch sensor 530 when a user moves their finger along the length of the touch sensor 530.

Using the methods described above for detecting a decay time below a particular threshold, the test and measurement instrument 500 is configured to determine that a user is touching a particular location along the primary line 532 and the secondary line 534, and the instrument is further configured to detect movement of the user's finger along the primary line 532 and the secondary line 534. In other words, if a user slides their finger from the bottom of the touch sensor 530 to the top, the cursor 512 may respond by moving from the left side of the display 510 to the right side, and vice versa. Although FIG. 5 shows the cursor 512 as being parallel to the y-axis of the display 510, the cursor 512 may also be parallel to the x-axis in additional or alternative configurations, and movement of a user's finger along the touch sensor 530 may move the cursor up and down.

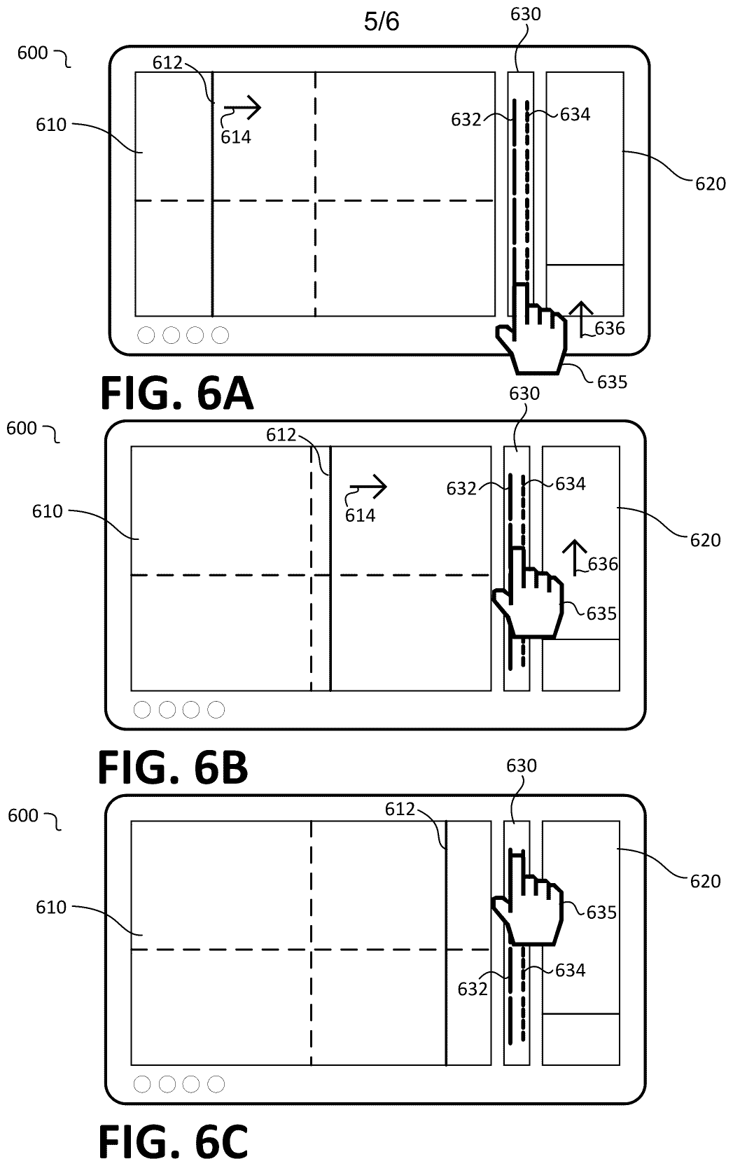

FIGS. 6A-6C show an example test and measurement instrument 600, demonstrating movement of a cursor 612 using a touch sensor 630. The test and measurement instrument 600 is similar to the example just discussed with regard to FIG. 5 and has a display 610, a user interface 620, and a touch sensor 630 with a primary line 632 and a secondary line 634. Referring first to FIG. 6A, as illustrated, as cursor 612 is positioned toward the left side of the display. Additionally, a user is shown as providing a directional touch to the touch sensor 630, represented with a hand 635 moving in the direction of an arrow 636. When the user's hand 635 moves in the direction of the arrow 636, the cursor 612 responds by moving in the direction of the cursor arrow 614.

As the user's hand 635 continues along the length of the touch sensor 630, as shown in FIG. 6B, the cursor 612 continues to move in the direction of the cursor arrow 614, from the left side of the display 610 toward the right side. When the user's hand 635 further continues in the direction of arrow 636, the user's hand 635 ultimately reaches the end of the touch sensor 630, as illustrated in FIG. 6C. Once the user's hand 635 reaches the end of the touch sensor 630 and stops, the cursor 612 reaches the right side of the display 610 and also stops in its current position.

In some configurations of the disclosed touch sensor, the touch sensor is implemented to control the cursor as a flywheel, i.e., as if the cursor has rotational inertia that decays over time, referred to herein as virtual rotational inertia. That is, when the user moves their finger along the touch sensor, the sensor responds as if the user has provided a stroking force to turn a physical wheel—and therefore, when the user removes their finger, the wheel continues to turn due to the rotational inertia of the wheel. In this way, the user can move their finger from the bottom of the touch sensor to the top, as shown and described with regard to FIGS. 6A-6C, remove their finger at the top, then once again move their finger from bottom to top to continue turning the “wheel.”

Although described herein as a flywheel, it should be understood that movement of a hypothetical “wheel” represents continuous sensor response. In other words, if a movement along the disclosed touch sensor is configured to move a cursor from one side of screen to another, implementation of the touch sensor as a flywheel causes the cursor to continue moving until a subsequent touch indicates that the movement should stop—i.e., the user stops their finger in a particular location on the touch sensor.

Moreover, in some configurations, the user can adjust the speed of the wheel and the speed of the sensor response depending how quickly they move their finger along the touch sensor. When the touch sensor is configured to control the position of a cursor, for instance, a quick movement of the user's finger along the touch sensor will cause the cursor to move quickly from one side of the screen to the other, and the cursor will continue moving when the user removes their finger. If the user then slowly moves their finger along the touch sensor, the flywheel response will slow down as well, and the cursor will begin to move across the screen more slowly.

Although example implementations of the disclosed touch sensor have been described as controlling the position of a cursor on a test and measurement display, still other operations of a test and measurement instrument are controllable with the disclosed touch sensor. In some configurations, the touch sensor is configured to zoom in and out of a display or otherwise resize the display window. In still other configurations, the touch sensor is configured to increment or decrement particular test parameters. Additionally, in example implementations of the touch sensor with a test and measurement instrument, the user may customize the operations controlled by the touch sensor and may change its functionality while actively using the test and measurement instrument.

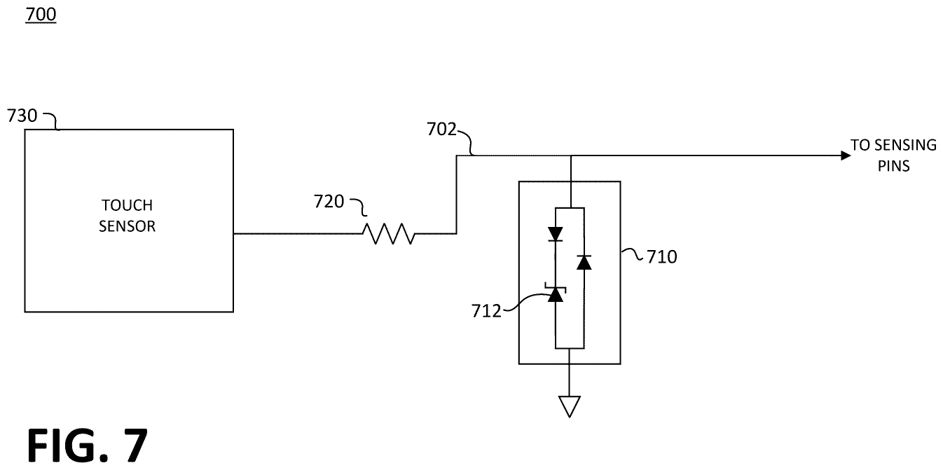

Because the disclosed touch sensor implements electrically conductive components externally accessible by a user, as discussed with regard to FIGS. 2-3, configurations of the disclosed technology further implement circuitry to mitigate the effects of external electrical fields on a sensing line coupled the sensors. More specifically, FIG. 7 shows an example ESD protection circuit 700 for minimizing possible damage or disruption to the sensor from ESD paths into the sensor. A copy of the protection circuit 700 is coupled to each individual sensor, although FIG. 7 shows only once such instance. As shown, the ESD protection circuit 700 includes a group of ESD diodes 710 and series resistance 720 to mitigate possible direct current paths through the return sensing path, such as through the I/O pins described above, to ground. Specifically, within group of ESD diodes 710 is an avalanche breakdown diode 712. When any voltage is present on the sensing line, here illustrated as line 702 from touch tensor 730, that exceeds the breakdown voltage of the breakdown diode 712, the breakdown diode enters its breakdown state to create a direct electrical connection between the line 702 and a reference voltage, such as a ground voltage, allowing the line 712 to discharge its energy directly to ground through the breakdown diode. After the line 702 has been discharged to the ground voltage, the breakdown diode 712 returns to its voltage blocking state. Thus, despite the sensor's conductive components being exposed to the external environment, the overall effectiveness of the sensor is not inhibited by potential ESD effects.

As previously discussed, existing touch-based control systems are either resistive or capacitive, and each has disadvantages. With resistive touch systems, the sensors often degrade due to repeated deformation over time, and the sensors cannot recognize multiple touch points at a time. While capacitive systems are less vulnerable to degradation and are capable of recognize multiple touch points, they are complex and vulnerable to interference from external electrical fields. Configurations of the disclosed touch sensor carry the benefits of both resistive and capacitive touch systems while addressing the disadvantages of each.

In particular, the disclosed touch sensor provides a simple system for detecting a location or multiple locations on the sensor, requiring only conductive wire and basic circuit logic. Configurations of the disclosed touch sensor do not require any deformation of the conductive wires and are therefore less vulnerable to degradation over time than resistive touch systems. And, as discussed above, adding ESD diodes and series resistances to the disclosed touch system limits any potentially negative effects of external electrical fields. Configurations of the disclosed touch sensor are also inexpensive, due to the use of simple conductive wires rather than expensive resistive membranes.

Additionally, because configurations of the disclosed technology implement physical wires broken into particular segments, a user interacting with an example touch sensor receives some degree of tactile feedback from the sensor to keep track of their position. In this way, a user of a test and measurement system implementing a touch sensor as disclosed herein can maintain their focus on the instrument's display. The user can control scrolling, zooming, or other operations using the disclosed touch sensor without having to take their eyes off the display. Thus, the disclosed touch sensor provides a simple touch system for operating a test and measurement instrument that does not require breakable mechanical components, such as knobs or other rotary encoders.

Aspects may operate on a particularly created hardware, on firmware, digital signal processors, or on a specially programmed general purpose computer including a processor operating according to programmed instructions. The terms “controller” or “processor” as used herein are intended to include microprocessors, microcomputers, ASICs, and dedicated hardware controllers. One or more aspects may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, RAM, etc. As will be appreciated by one of skill in the art, the functionality of the program modules may be combined or distributed as desired in various configurations. In addition, the functionality may be embodied in whole or in part in firmware or hardware equivalents such as integrated circuits, field programmable gate arrays (FPGA), and the like. Particular data structures may be used to more effectively implement one or more aspects of the disclosed systems and methods, and such data structures are contemplated within the scope of computer executable instructions and computer-usable data described herein.

The previously described versions of the disclosed subject matter have many advantages that were either described or would be apparent to a person of ordinary skill. Even so, all of these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular example configuration, that feature can also be used, to the extent possible, in the context of other example configurations.

Also, when reference is made in this application to a method having two or more defined steps or operations, the defined steps or operations can be carried out in any order or simultaneously, unless the context excludes those possibilities.

Furthermore, the term “comprises” and its grammatical equivalents are used in this application to mean that other components, features, steps, processes, operations, etc. are optionally present. For example, an article “comprising” or “which comprises” components A, B, and C can contain only components A, B, and C, or it can contain components A, B, and C along with one or more other components.

Also, directions such as “vertical,” “horizontal,” “right,” and “left” are used for convenience and in reference to the views provided in figures. But the disclosed touch sensor may have a number of orientations in actual use. Thus, a feature that is vertical, horizontal, to the right, or to the left in the figures may not have that same orientation or direction in actual use.

Although specific example configurations have been described for purposes of illustration, it will be understood that various modifications may be made without departing from the spirit and scope of the disclosure.

We claim:

1. A touch sensor for sensing a position of a user's touch, the touch sensor comprising:
a first conductive material separated into one or more primary segments;
a second conductive material positioned a predetermined distance from the first conductive material; and
a controller configured to:
receive input from each of the one or more primary segments of the first conductive material, and
based on the received input, determine whether a touch is present at one of the one or more primary segments.

2. The touch sensor of claim 1, in which the predetermined distance between the first conductive material and the second conductive material is sized to allow a human finger to simultaneously contact the first conductive material and the second conductive material.

3. The touch sensor of claim 1, in which the controller is further configured to charge the first conductive material to a first voltage.

4. The touch sensor of claim 3, in which the received input includes one or more measured voltage decay times at each of the one or more primary segments.

5. The touch sensor of claim 4, in which the controller is configured to determine that a touch is present at one of the one or more primary segments when one of the one or more measured voltage decay times is below a predetermined threshold.

6. The touch sensor of claim 3, in which the second conductive material is separated into one or more secondary segments, and in which the controller is further configured to receive input from each of the one or more secondary segments.

7. The touch sensor of claim 6, in which the received input further includes one or more measured voltage decay times from each of the one or more secondary segments.

8. The touch sensor of claim 6, in which the quantity of the one or more secondary segments is greater than the quantity of the one or more primary segments.

9. The touch sensor of claim 1, further comprising one or more electro-static discharge protection circuits respectively coupled to the one or more primary segments.

10. A test and measurement system, comprising:
a test and measurement instrument having a display;
a touch sensor coupled to the test and measurement instrument, the touch sensor having:
a first conductive material separated into one or more primary segments, and
a second conductive material positioned a predetermined distance from the first conductive material; and
a controller configured to receive input from the touch sensor, and based on the received input, adjust the display of the test and measurement instrument.

11. The test and measurement system of claim 10, in which the controller is further configured to charge the first conductive material to a first voltage.

12. The test and measurement system of claim 11, in which the received input includes one or more measured voltage decay times at each of the one or more primary segments.

13. The test and measurement system of claim 11, in which the controller is further configured to determine that a touch is present at one of the one or more primary segments when one of the one or more measured voltage decay times is below a predetermined threshold.

14. The test and measurement system of claim 10, in which the second conductive material is separated into one or more secondary segments, and in which the controller is further configured to receive input from each of the one or more secondary segments.

15. The test and measurement system of claim 14, in which the received input further includes one or more measured voltage decay times from each of the one or more secondary segments.

16. The test and measurement system of claim 10, in which adjusting the display comprises moving a cursor on the display.

17. The test and measurement system of claim 10, in which the predetermined distance between the first conductive material and the second conductive material is sized to allow a human finger to simultaneously contact the first conductive material and the second conductive material.

18. The test and measurement system of claim 14, in which the quantity of the one or more secondary segments is greater than the quantity of the one or more primary segments.

19. The test and measurement system of claim 10, in which the controller is further configured to determine that a stroking motion has been applied to the touch sensor.

20. The test and measurement system of claim 19, in which the controller is further configured to determine an amount of virtual rotational inertia of the stroking motion and continuously adjust the display until a subsequent touch is detected or the virtual rotational inertia decays.

21. A method of detecting a location of a touch on a touch sensor having a first conductive material and a second conductive material, the second conductive material being positioned a predetermined distance from the first conductive material, and the first conductive material being separated into one or more primary segments, the method comprising the steps of:
sending, with a controller, a pulse of a first voltage to the first conductive material;
measuring one or more voltage decay times at each of the one or more primary segments; and
determining whether one of the one or more measured voltage decay times is below a predetermined threshold.

22. The method of claim 21, in which the second conductive material is separated into one or more secondary segments, and in which the method further comprises measuring one or more voltage decay times at each of the one or more secondary segments.

23. The method of claim 21, in which the predetermined threshold is a known decay time of the first conductive material when a touch is not present.
